(19) United States
(12) Patent Application Publication
(10) Pub. No.: US 2013/0021155 A1
(43) Pub. Date: Jan. 24, 2013

(54) DETECTION CIRCUIT, DETECTION SYSTEM, AND METHOD OF ASSEMBLING A DETECTION SYSTEM

(71) Applicants: Miguel Angel Perez Gandara, Barcelona (ES); Jairo Munoz Rodriguez, Barcelona (ES)

(72) Inventors: Miguel Angel Perez Gandara, Barcelona (ES); Jairo Munoz Rodriguez, Barcelona (ES)

(73) Assignee: UTC FIRE & SECURITY AMERICAS CORPORATION,INC., Bradenton, FL (US)

(21) Appl. No.: 13/576,391

(22) PCT Filed: Jul. 27, 2010
(86) PCT No.: PCT/US2010/043318

§ 371 Date: Oct. 9, 2012

(30) Foreign Application Priority Data
Feb. 2, 2010 (ES) 201030139

(51) Int. Cl. G05F 3/00; H01R 43/00; G08B 21/00

(52) U.S. Cl. 340/540; 323/304; 29/825; 29/593

(57) ABSTRACT

A detection circuit for use in detecting hazardous conditions includes a first conductor (142) and a second conductor (144). The first conductor and the second conductor couple at least one initiating device (138) to a detection control panel (104) configured to detect hazardous conditions. A voltage-stabilizing device (140) is configured to stabilize a voltage between the first conductor and the second conductor. A method of assembling a detection system includes coupling a first conductor and a second conductor to at least one initiating device to form a detection circuit, and coupling a voltage-stabilizing device to the first conductor and the second conductor, wherein the voltage-stabilizing device is configured to stabilize a voltage between the first conductor and the second conductor. The first conductor and the second conductor are coupled to a detection control panel configured to detect a hazardous condition.

### BACKGROUND OF THE INVENTION

This application claims the priority of Spanish Patent Application Serial Number 201030139, filed Feb. 2, 2010, which is hereby incorporated by reference in its entirety.

### FIELD OF THE INVENTION

The embodiments described herein relate to detection systems generally and more specifically, to a detection circuit, a detection system, and a method for assembling a detection system for detecting hazardous conditions such as fires or smoke.

### DESCRIPTION OF RELATED ART

Some buildings have one or more systems that detect hazardous conditions, such as fires and/or smoke. Conventional detection systems include one or more initiating devices. Initiating devices may include sensors (for detecting smoke, heat, or other conditions) or manual call points or pull stations (which are manually activated when a hazardous condition is detected). Conventional detection systems also include a control panel for aggregating data from the initiating devices and reporting hazardous conditions to one or more monitoring devices and/or personnel. The initiating devices of conventional detection systems are arranged in one or more detection circuits that each include an end of line resistor to control a current and/or an impedance within the detection circuit.

The detection circuits include a plurality of electrical wires that couple the detection circuit components together. The electrical wires may degrade over time and an impedance of the electrical wires may increase. Similarly, an impedance of other detection circuit components may decrease or change over time. This change in impedance may reduce an amount of voltage available to the detection circuit components and the change in impedance must be indicated as a fault condition according to certain regulations. At least some conventional detection systems do not detect such impedance changes and/or reduced voltages in the detection circuits. As such, at least some detection circuit components may not operate correctly and a fire or other hazardous condition may not be detected.

### BRIEF SUMMARY OF THE INVENTION

In one aspect, a detection circuit for use in detecting hazardous conditions is provided. The detection circuit includes a first conductor, a second conductor, and at least one initiating device coupled by the first conductor and by the second conductor to a detection control panel configured to detect hazardous conditions. The detection circuit also includes a voltage-stabilizing device configured to stabilize a voltage between the first conductor and the second conductor.

In another aspect, a detection system is provided that includes a detection control panel configured to detect a hazardous condition and to display a notification of the hazardous condition. The detection system also includes at least one detection circuit coupled to the detection panel. The detection circuit includes a first conductor, a second conductor, and at least one initiating device coupled to the detection control panel by the first conductor and by the second conductor. The detection circuit also includes a voltage-stabilizing device configured to stabilize a voltage between the first conductor and the second conductor.

In yet another aspect, a method of assembling a detection system is provided. A first conductor and a second conductor are coupled to at least one initiating device to form a detection circuit, and a voltage-stabilizing device is coupled to the first conductor and the second conductor. The voltage-stabilizing device is configured to stabilize a voltage between the first conductor and the second conductor. The first conductor and the second conductor are coupled to a detection control panel configured to detect a hazardous condition.

The embodiments described herein provide a stable voltage level within a detection circuit. The stable voltage within the detection circuit enables a detection system to detect one or more faults or alarms that occur within the detection circuit. The detection system monitors a voltage level within the detection circuit and compares the voltage level with one or more detection thresholds to determine if one or more fault or alarm conditions are present within the detection circuit. Moreover, the embodiments described herein enable the detection system to comply with one or more revised safety standards while maintaining backward compatibility with current and/or legacy initiating devices.

### BRIEF DESCRIPTION OF THE DRAWINGS

FIGS. 1-4 show exemplary embodiments of the systems and method described herein.

FIG. 1 is a block diagram of an exemplary detection system.

FIG. 2 is a circuit diagram of a portion of an exemplary detection circuit interface and a portion of an exemplary detection circuit suitable for use with the detection system shown in FIG. 1.

FIG. 3 is a block diagram of a plurality of detection states suitable for use with the detection system shown in FIG. 1.

FIG. 4 is a flow diagram of an exemplary method for monitoring a detection circuit suitable for use with the detection system shown in FIG. 1.

### DETAILED DESCRIPTION OF THE INVENTION

The embodiments described herein use a voltage-stabilizing device to provide a substantially stable voltage within a detection circuit of a detection system. The voltage-stabilizing device provides a stable voltage level within the detection circuit during a quiescent state. The detection system monitors a voltage level in the detection circuit and compares the voltage level to a plurality of detection thresholds. If the voltage level increases above or decreases below one or more voltage thresholds associated with the quiescent state, the detection system may determine that one or more faults or alarms have occurred. As such, the detection circuit and the voltage-stabilizing device enable the detection system to detect a plurality of fault or alarm conditions, such as a short circuit fault, an alarm, and an open circuit fault. Moreover, the detection circuit enables the detection system to detect a high impedance level within the detection circuit that prior art systems may not detect. The detection circuit and detection system facilitate cost-effective compliance with one or more safety regulations, such as the current European Standard EN54-13, as well as maintaining backwards compatibility current and/or legacy initiating devices.

Although the security system as described herein includes one or more initiating devices, it should be understood that the systems and method described herein may include any suitable device that transmits measurements of environmental conditions to a control system configured to receive the measurements.

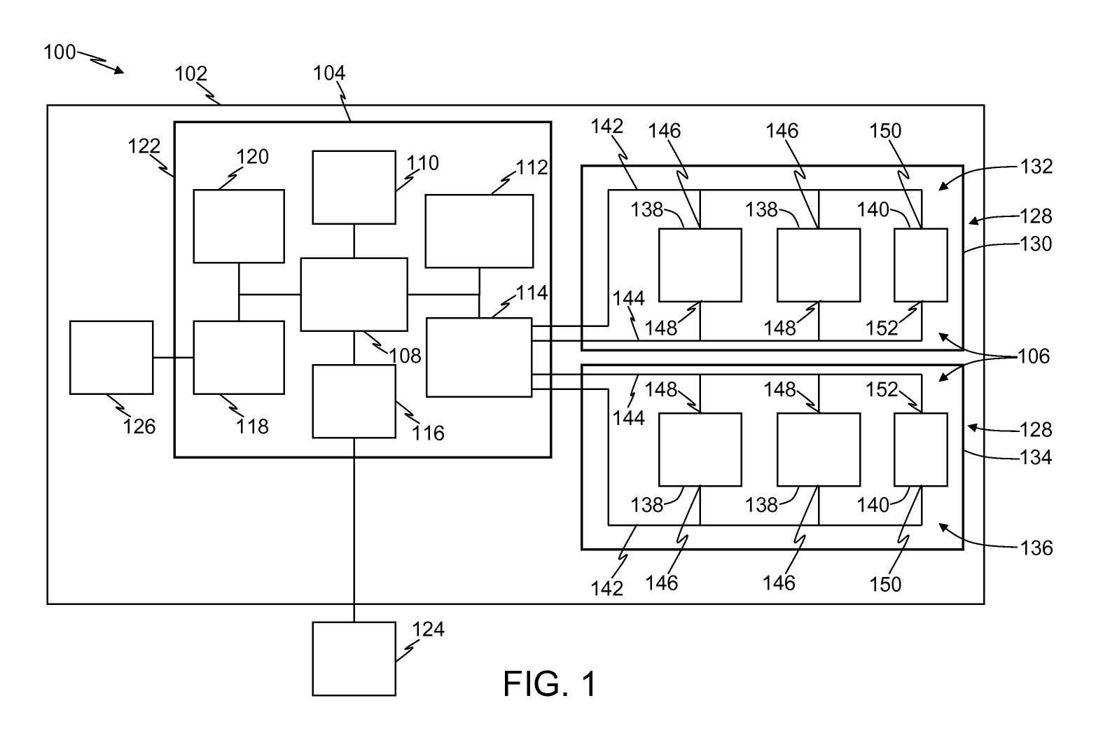

FIG. 1 shows an exemplary detection system 100 for monitoring a building 102. Building 102 is a residential, commercial, or industrial structure or any suitable structure. In the exemplary embodiment, detection system 100 includes a detection control panel 104 and at least one detection circuit 106. Detection system 100 detects one or more hazardous or emergency conditions, such as smoke and/or fire, within building 102. Alternatively, detection system 100 detects any suitable condition within building 102. In one embodiment, building includes a plurality of detection systems 100, detection control panels 104, and/or detection circuits 106.

In the exemplary embodiment, detection control panel 104 includes a controller 108, a display 110, a memory 112, a detection circuit interface 114, a communication module 116, a peripheral interface 118, and a user interface 120 that are positioned within a housing 122. Housing 122 also includes power supply circuitry (not shown) and/or any suitable component.

Controller 108 includes a processor that controls an operation of detection control panel 104 and/or of detection system 100. As used herein, the term “processor” broadly refers to a microprocessor, microcontroller, programmable logic controller (PLC), reduced instruction set computer (RISC), a programmable gate array (PGA), application specific integrated circuit (ASIC), and/or any other programmable circuit, and these terms are used interchangeably herein.

Display 110 is optional, and if present, is operatively coupled to controller 108. Display 110 includes a liquid crystal display (LCD), a cathode ray tube (CRT), a plasma display, and/or any other suitable type of visual output device capable of displaying data to a user.

Memory 112 includes, without limitation, a computer readable medium, such as a hard disk drive, a solid-state drive, a diskette, a flash drive, a compact disc, a digital video disc, and/or random access memory (RAM).

Detection circuit interface 114 includes a plurality of ports (not shown) that couple to one or more detection circuits 106. Detection circuit interface 114 uses a plurality of electronic conditioners and/or any suitable coupling mechanism to couple to detection circuits 106. Alternatively, detection system 100 does not include detection circuit interface 114, and detection circuits 106 are coupled to controller 108 and/or to any suitable component of detection control panel 104 and/or detection system 100.

Communication module 116 includes, without limitation, a network interface controller (NIC), a network adapter, a transceiver, a public switched telephone network (PSTN) interface controller, or any other communication device that enables detection system 100 to operate as described herein. Communication module 116 remotely communicates with a remote device 124 located remotely from building 102 and/or from detection control panel 104. In one embodiment, if detection system 100 detects a hazardous condition, communication module 116 transmits a notification of the hazardous condition to remote device 124. Remote device 124 includes, without limitation, an alarm monitoring company, a fire department, and/or any suitable emergency response organization.

Peripheral interface 118 includes a plurality of ports (not shown) that couple to one or more peripheral devices 126. Peripheral interface 118 uses a plurality of electronic conditioners and/or any suitable coupling mechanism to couple to peripheral devices 126. Peripheral devices 126 include, without limitation, one or more audial and/or visual alarm devices or notification devices, one or more supervisory devices, and/or any suitable device that enables detection system 100 to operate as described herein.

User interface 120 includes, without limitation, a keyboard, a keypad, a mouse, a pointing device, a touch sensitive screen, and/or an audio input device. A user may operate user interface 120 to program detection control panel 104 and/or controller 108, to retrieve data from detection control panel 104, and/or to control an operation of detection control panel 104 and/or detection system 100. In one embodiment and in order to comply with regulations, user interface 120 includes a plurality of light-emitting diodes (LEDs) or other light-emitting devices that display one or more operating conditions, one or more alarm, fault, and/or hazardous condition notifications, and/or a status of detection system 100.

In the exemplary embodiment, detection system 100 includes a plurality of detection circuits 106 that are grouped according to zones 128. Detection system 100 includes any suitable number of zones 128, and each zone 128 includes any suitable number of detection circuits 106 (also known as zone detection circuits). In the exemplary embodiment, each zone 128 includes a single detection circuit 106. In one embodiment, detection system 100 includes a first zone 130 having a first detection circuit 132 and a second zone 134 having a second detection circuit 136.

Each detection circuit 106 includes at least one initiating device 138, such as a sensor, and at least one end of line component, such as a voltage-stabilizing device 140, that are coupled together by a plurality of conductors, such as a first conductor 142 and a second conductor 144. Initiating devices 138 and voltage-stabilizing device 140 are coupled in parallel with each other between first conductor 142 and second conductor 144. More specifically, a first terminal 146 of each initiating device 138 is coupled to first conductor 142 and a second terminal 148 of each initiating device 138 is coupled to second conductor 144. A first terminal 150 of voltage-stabilizing device 140 is coupled to first conductor 142 (and thereby to first terminal 146 of each initiating device 138), and a second terminal 152 of voltage-stabilizing device 140 is coupled to second conductor 144 (and thereby to second terminal 148 of each initiating device 138). Alternatively, each detection circuit 106 of each zone 128 may have any suitable configuration.

Initiating devices 138 are located remotely from detection control panel 104. Initiating devices 138 include, without limitation, a smoke detector, a heat detector, a water flow detector, a carbon monoxide detector, and/or any suitable device that enables detection system 100 to operate as described herein. Initiating devices 138 transmit a detection notification, such as a predefined amount of current or impedance, to detection control panel 104 if a measured environmental condition exceeds a predefined threshold or otherwise satisfies a detection condition. For example, if initiating device 138 is a smoke detector, a detection condition may include detecting a predefined concentration of particulates in a predefined volume of air. Alternatively or additionally, initiating devices 138 include one or more manually-activated initiating devices (also known as manual call points or pull stations) that transmit a detection notification to detection control panel 104 when a user operates the initiating device. In the exemplary embodiment, initiating devices 138 are configured to operate substantially as switches or relays. Moreover, initiating devices 138 each include a series resistor (not shown) that controls an amount of current transmitted through initiating device 138 when a detection condition is satisfied. Initiating device 138 operates similarly to a closed switch when a detection condition is satisfied, and substantially increases or enables an amount of current to be transmitted from first conductor 142 to second conductor 144 through initiating device 138. The current flowing through initiating device 138 produces a voltage across the series resistor. Controller 108 and/or detection control panel 104 detects the current and/or voltage and determines that an alarm has been generated by initiating device 138. If a detection condition is not satisfied, initiating device 138 operates similarly to an open switch and substantially reduces or prevents an amount of current transmitted from first conductor 142 to second conductor 144 through initiating device 138. As such, current flows through voltage-stabilizing device 140 as more fully described herein.

In the exemplary embodiment, voltage-stabilizing device 140 includes a Zener diode. In one embodiment, a resistor (not shown) is positioned within detection circuit interface 114 of the detection control panel 104 and is coupled in series with voltage-stabilizing device 140 to control a current through voltage-stabilizing device 140 using first conductor 142. In an alternative embodiment, voltage-stabilizing device 140 includes an avalanche diode, an operational amplifier coupled to a diode, and/or any suitable component that enables detection system 100 to operate as described herein.

During operation, detection control panel 104 supplies a voltage, such as, for example, about 24 volts (V) direct current (DC), to detection circuits 106. Detection control panel 104 and/or controller 108 monitors each detection circuit 106 through detection circuit interface 114, for example, by monitoring a voltage, a current, and/or an impedance within detection circuit 106, first conductor 142, and/or second conductor 144. Detection control panel 104 and/or controller 108 detects an amount of voltage received from first conductor 142 and determines whether initiating device 138 has satisfied a detection condition (i.e., an initiating device has “triggered”). If initiating device 138 has triggered, detection control panel 104 and/or controller 108 determines a response to the satisfied detection condition and implements the response. For example, detection control panel 104 and/or controller 108 generates one or more alarms by operating one or more peripheral devices 126, initiates a call and/or a data transmission to remote device 124 using communication module 116, displays a notification of the satisfied detection condition on display 110 and/or user interface 120, and/or generates any suitable response. If detection control panel 104 and/or controller 108 determines that no initiating devices 138 have triggered, detection control panel 104 and/or controller 108 continues to monitor detection circuits 106.

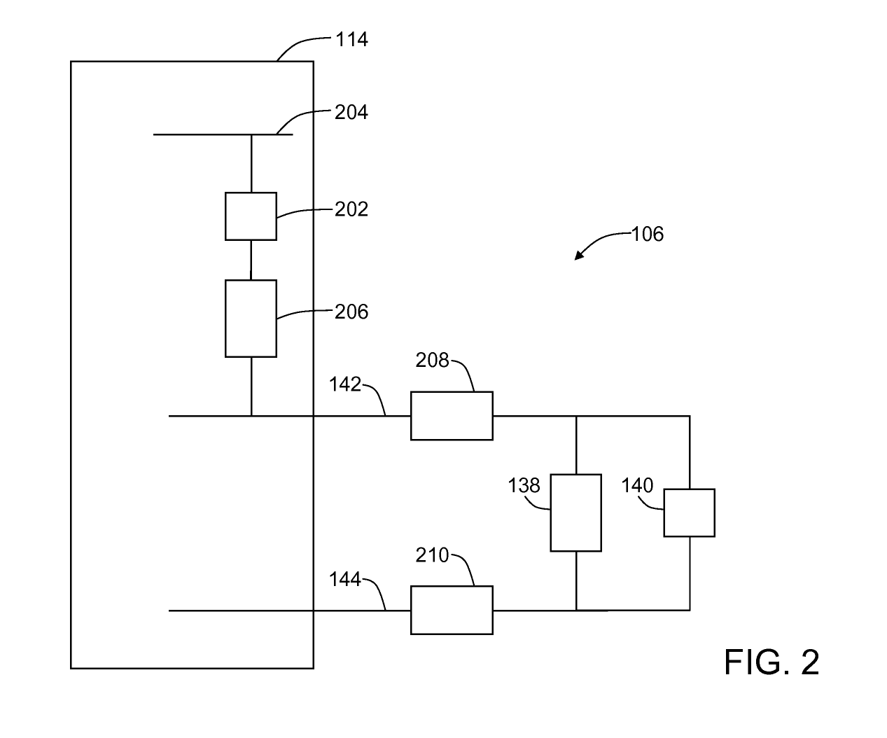

FIG. 2 shows a circuit diagram of a portion of detection circuit interface 114 of detection control panel 104 (shown in FIG. 1) and a portion of detection circuit 106. In the exemplary embodiment, detection circuit interface 114 includes a reverse current protection device 202 coupled to a power source 204 and to a pull-up resistor 206. Alternatively, reverse current protection device 202, power source 204, and/or pull-up resistor 206 are included within a different portion of detection control panel 104, within detection circuit 106, and/or within any suitable circuit or system.

In the exemplary embodiment, power source 204 supplies about 24 volts (V) direct current (DC) to detection circuit 106 and is coupled to the power supply circuitry of detection control panel 104. Alternatively, power source 204 supplies any suitable power, voltage, and/or current to detection circuit 106. Reverse current protection device 202 facilitates protecting power source 204 from being damaged by current flowing from pull-up resistor 206 to power source 204. Reverse current protection device 202 is a diode, such as a Schottky diode, and/or any suitable device. Pull-up resistor 206 is selected to set proper detection thresholds when coupled to detection circuit 106. In one embodiment, pull-up resistor 206 is about 390 ohms Alternatively, pull-up resistor 206 has any suitable resistance value. Pull-up resistor 206 is coupled to first conductor 142.

First conductor 142 and second conductor 144 exhibit resistance characteristics within detection circuit 106 that are represented by a respective first conductor resistance 208 and a second conductor resistance 210. First conductor resistance 208 and second conductor resistance 210 values vary based on, for example, a size and/or a composition of first conductor 142 and/or second conductor 144. In one embodiment, first conductor resistance 208 and second conductor resistance 210 are each lower than about 100 ohms, such as, for example, less than about 50 ohms As used herein, the terms “resistance” and “impedance” are used interchangeably as detection system 100 and/or detection circuit 106 operates with substantially DC voltages. Alternatively, detection system 100 and/or detection circuit 106 operate with substantially alternating current (AC) voltages, and “impedance” is substituted herein for “resistance” as applicable.

During operation, power source 204 supplies a voltage, such as about 24 VDC, to detection circuit 106. The voltage is decreased by a voltage across reverse current protection device 202 and a voltage across pull-up resistor 206, and the remaining voltage reverse-biases voltage-stabilizing device 140. Voltage-stabilizing device 140 is selected to have a reverse breakdown voltage, such as a Zener voltage, suitable for detecting high impedance values within detection circuit 106. In the exemplary embodiment, the reverse breakdown voltage is about 18 V. Alternatively, any suitable reverse breakdown voltage is selected that enables initiating devices 138 to operate properly. If power source 204 reverse-biases voltage-stabilizing device 140 to a voltage level above the reverse breakdown voltage, voltage-stabilizing device 140 conducts current and provides a substantially stable voltage to detection circuit 106. If the reverse-bias voltage decreases below the reverse breakdown voltage, voltage-stabilizing device 140 substantially stops conducting current and does not provide a substantially stable voltage to detection circuit 106.

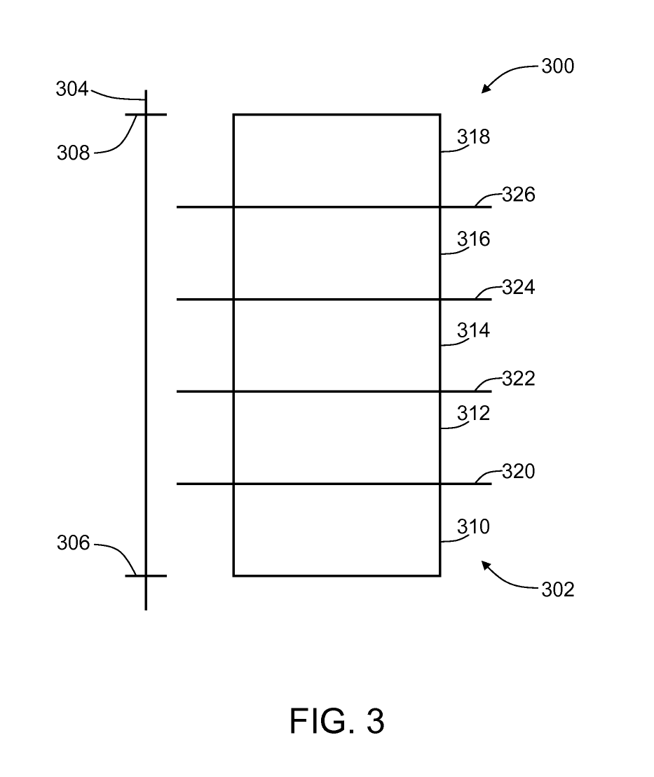

FIG. 3 shows a plurality of exemplary detection states 300 suitable for use with detection system 100 (shown in FIG. 1) and detection circuit 106 (shown in FIG. 2). In the exemplary embodiment, detection control panel 104 (shown in FIG. 1) measures a voltage (hereinafter referred to as “the detection voltage”) between first conductor 142 and second conductor 144 (both shown in FIG. 1) and compares the detection voltage with a plurality of detection thresholds 302 to determine a detection state 300 of detection circuit 106. As used herein, the term “detection state” refers to a logical mode of operation that detection system 100 enters if the detection voltage crosses a particular detection threshold 302. Although FIG. 3 shows five detection states 310, 213, 314, 316, and 318 and four detection thresholds 320, 322, 324, and 326, any suitable number of detection states 300 and/or detection thresholds 302 may be used with detection system 100.

In the exemplary embodiment, detection thresholds 302 and detection states 300 are arranged at increasing levels on a voltage scale 304. Voltage scale 304 spans a range from a voltage minimum 306 to a voltage maximum 308. Voltage minimum 306 is equal to about 0 V and/or about equal to ground potential. Voltage maximum is equal to about 24 V and/or about equal to a voltage level supplied by power source 204 (shown in FIG. 2). Alternatively, voltage minimum 306 and/or voltage maximum 308 are equal to any suitable voltages.

In the exemplary embodiment, detection states 300 include a short fault state 310, an alarm state 312, an impedance fault state 314, a quiescent state 316, and an open fault state 318. Detection system 100 enters short fault state 310 if the detection voltage is between voltage minimum 306 and a first detection threshold 320. For example, detection system 100 enters short fault state 310 if a short circuit is detected within detection circuit 106. If a short circuit occurs within detection circuit 106, current substantially bypasses voltage-stabilizing device 140 (shown in FIG. 1) and other components of detection circuit 106. Current flows from first conductor 142 to second conductor 144 through the short circuit such that the detection voltage is substantially zero and/or below first detection threshold 320.

Detection system 100 enters alarm state 312 if the detection voltage is between first detection threshold 320 and a second detection threshold 322. For example, detection system enters alarm state 312 if one or more initiating devices 138 (shown in FIG. 1) are triggered. Upon triggering, initiating device 138 couples first conductor 142 to second conductor 144 through a series resistor of initiating device 138 or any other method. Current flows through initiating device 138 and generates a voltage across initiating device 138. In the exemplary embodiment, first detection threshold 320 and second detection threshold 322 are selected such that the voltage across initiating device 138 is between first detection threshold 320 and second detection threshold 322.

Impedance fault state 314 is entered if the detection voltage is between second detection threshold 322 and a third detection threshold 324. For example, detection system 100 enters impedance fault state 314 if a parallel impedance within detection circuit 106, such as an impedance between first conductor 142 and second conductor 144, decreases a suitable amount. Alternatively or additionally, detection system 100 enters impedance fault state 314 if a series impedance, such as an impedance of first conductor 142 and/or second conductor 144 increases a suitable amount. During operation, a structural integrity of one or more components within detection circuit 106 may degrade due to friction, erosion, and/or other causes. Such degradation may cause an impedance within one or more components to decrease and/or change either gradually or suddenly. If the parallel impedance of a component of detection circuit 106 decreases, for example, due to one or more degraded initiating devices 138, a voltage presented to voltage-stabilizing device 140 from power source 204 decreases due to a voltage division resulting from pull-up resistor 206. If the voltage decreases below the reverse breakdown voltage, voltage-stabilizing device 140 stops producing a stable voltage across first conductor 142 and second conductor 144. As a result, the detection voltage decreases below third detection threshold 324. Second detection threshold 322 and third detection threshold 324 are selected such that impedance fault state 314 is positioned suitably between alarm state 312 and quiescent state 316. Moreover, detection control panel 104 and/or controller 108 (shown in FIG. 1) can detect a high, low, and/or changed impedance level within detection circuit 106 and an alarm or fault notification can be generated in response. In the exemplary embodiment, the impedance level of detection circuit 106 associated with impedance fault state 314 is higher than an impedance level of detection circuit 106 associated with alarm state 312, and lower than an impedance level associated with quiescent state 316.

When detection system 100 is operating within a normal or quiescent state 316, power source 204 reverse-biases voltage-stabilizing device 140 to a level above the reverse breakdown voltage. As such, voltage-stabilizing device 140 conducts current and produces a substantially stable voltage between first conductor 142 and second conductor 144. The detection voltage is substantially equal to the reverse breakdown voltage of voltage-stabilizing device 140. Third detection threshold 324 and a fourth detection threshold 326 are selected such that the detection voltage is between third detection threshold 324 and fourth detection threshold 326 during normal operation.

Detection system 100 enters open fault state 318 if the detection voltage is above fourth detection threshold 326. For example, detection system 100 enters open fault state 318 if an open circuit condition occurs within detection circuit 106. If a break or other suitable damage occurs within one or more components of detection circuit 106, such as, for example, first conductor 142, second conductor 144, voltage-stabilizing device 140 is electrically disconnected from detection circuit 106 and/or detection control panel 104 and current is substantially prevented from flowing through detection circuit 106. If current does not flow through detection circuit 106, the detection voltage is substantially equal to power source 204 and/or is above fourth detection threshold 326.

By comparing the detection voltage to first detection threshold 320, second detection threshold 322, third detection threshold 324, and/or fourth detection threshold 326, detection control panel 104 and/or controller 108 determines the detection state 300 of detection system 100. Once the detection state 300 has been determined, detection control panel 104 and/or controller 108 determines an appropriate response for the detection state 300. In one embodiment, the response for one detection state 300 is different and/or unique from a response for another detection state 300. Alternatively, one or more detection states 300 share one or more responses. The responses include, for example, continuing normal operation, generating an alarm, generating a fault notification, initiating a call and/or a data transmission to remote device 124 (shown in FIG. 1), displaying a notification of the detection state 300 on display 110 (shown in FIG. 1), and/or any suitable response. In one embodiment, detection control panel 104 and/or controller 108 generate an alarm and/or a fault notification if detection system 100 enters any detection state 300 other than the normal or quiescent state 316.

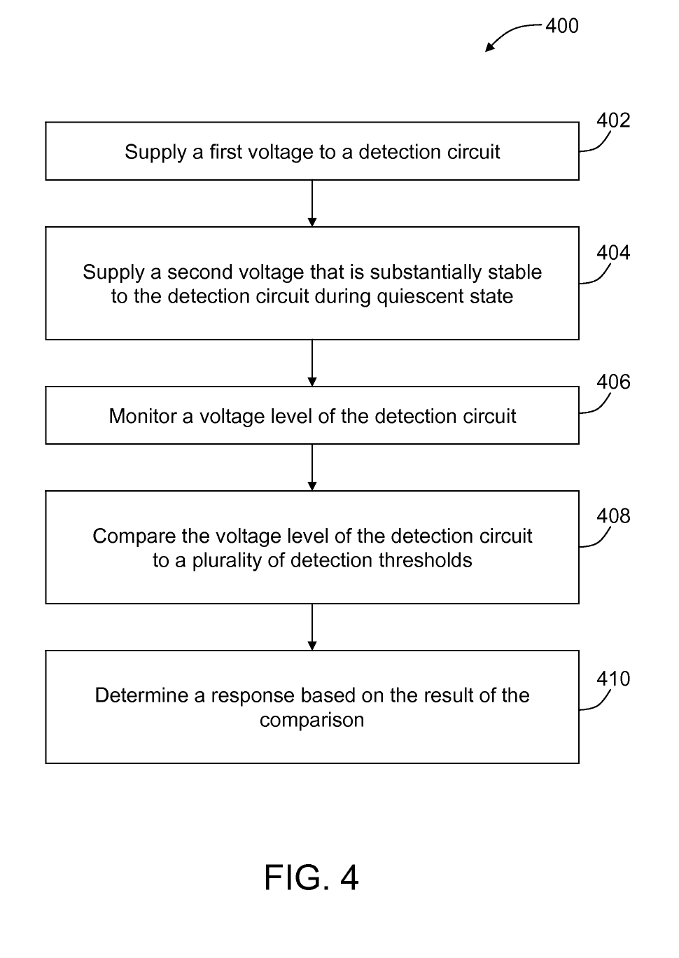

FIG. 4 shows an exemplary method 400 for monitoring a detection circuit, such as detection circuit 106 (shown in FIG. 1). In the exemplary embodiment, method 400 is used with detection system 100 (shown in FIG. 1). Method 400 includes supplying 402 a first voltage, such as a voltage from power source 204 (shown in FIG. 2), to detection circuit 106. The first voltage reverse-biases a second device, such as voltage-stabilizing device 140 (shown in FIG. 1). Voltage-stabilizing device 140 supplies 404 a second voltage that is substantially stable to detection circuit 106 during quiescent state 316 (shown in FIG. 3). The second voltage is lower than the first voltage and is substantially equal to the reverse breakdown voltage of voltage-stabilizing device 140. A voltage level of detection circuit 106 is monitored 406 by detection control panel 104 and/or controller 108. In the exemplary embodiment, the voltage level of detection circuit 106 that is monitored 406 is the detection voltage between first conductor 142 and second conductor 144 (both shown in FIG. 1). Alternatively, and suitable voltage within detection circuit 106 is monitored 406. The voltage level of detection circuit 106 is compared 408 to a plurality of detection thresholds. In the exemplary embodiment, detection control panel 104 and/or controller 108 compares 408 the voltage level of detection circuit 106 to first detection threshold 320, second detection threshold 322, third detection threshold 324, and fourth detection threshold 326. A response of detection system 100 is determined 410 based on the result of the comparison. For example, detection control panel 104 and/or controller 108 determine 410 a response for detection system 100, such as continuing normal operation, generating an alarm, generating a fault notification, initiating a call and/or a data transmission to remote device 124 (shown in FIG. 1), displaying a notification of the detection state 300 on display 110, and/or any suitable response.

In one embodiment, a method of assembling a detection system includes coupling a first conductor and a second conductor to at least one initiating device to form a detection circuit, coupling a voltage-stabilizing device to the first conductor and the second conductor, wherein the voltage-stabilizing device is configured to stabilize a voltage between the first conductor and the second conductor, and coupling the first conductor and the second conductor to a detection control panel configured to detect a hazardous condition. In another embodiment, coupling the voltage-stabilizing device to the first conductor and the second conductor includes coupling a diode to the first conductor and the second conductor, and in a more specific embodiment, coupling a Zener diode to the first conductor and the second conductor. In yet another embodiment, the method also includes coupling a power source to the first conductor such that the power source reverse-biases the Zener diode. In a still further embodiment, the method includes coupling a power source to the detection circuit such that the power source supplies a first voltage to the detection circuit and the voltage-stabilizing device supplies a second voltage to the detection circuit. Coupling the first conductor and the second conductor to a detection control panel further includes configuring the detection control panel to monitor a voltage level of the detection circuit and configuring the detection control panel to compare the voltage level of the detection circuit to a plurality of detection thresholds and determine a response based on the comparison.

The above-described embodiments facilitate providing a cost-effective and robust detection system for detecting fires and/or other hazardous conditions. The detection system uses a voltage-stabilizing device to provide a substantially stable voltage within a detection circuit. The voltage-stabilizing device enables the detection system to monitor a voltage level in the detection circuit and compare the voltage level to a plurality of detection thresholds. The detection circuit including the voltage-stabilizing device enables the detection system to detect a plurality of fault or alarm conditions, such as a short circuit fault, one or more alarms, and an open circuit fault. Moreover, the detection circuit enables the detection system to detect increases of serial impedance and/or decreases of parallel impedance within the detection circuit that prior art systems may not detect or report as faults. The detection circuit and detection system facilitate cost-effective compliance with one or more agency regulations, such as the current European Standard EN54-13, as well as maintaining backwards compatibility with current and/or legacy initiating devices.

A technical effect of the systems and method described herein includes at least one of: (a) supplying a stable voltage level to a detection circuit; (b) comparing a voltage level in a detection circuit to a plurality of detection thresholds; (c) generating an alarm or a fault notification based on a comparison of a voltage level with a plurality of detection thresholds; (d) detecting a high, low, or changed impedance level within a detection circuit; and (e) generating an alarm or a fault notification if a high, low, and/or changed impedance level is detected within a detection circuit.

Exemplary embodiments of a detection circuit, a detection system, and a method of assembling a detection system are described above in detail. The method and systems are not limited to the specific embodiments described herein, but rather, components of systems and/or steps of the method may be utilized independently and separately from other components and/or steps described herein. For example, the method may also be used in combination with other hazard detection systems and methods, and are not limited to practice with only the fire detection systems and method as described herein. Rather, the exemplary embodiment can be implemented and utilized in connection with many other detection applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A detection circuit for use in detecting hazardous conditions, said detection circuit comprising:
a first conductor and a second conductor;
at least one initiating device coupled to a detection control panel by said first conductor and by said second conductor, the detection control panel configured to detect hazardous conditions; and
a voltage-stabilizing device configured to stabilize a voltage between said first conductor and said second conductor.

2. A detection circuit in accordance with claim 1, wherein said voltage-stabilizing device is a diode.

3. A detection circuit in accordance with claim 1, wherein said voltage-stabilizing device is a Zener diode.

4. A detection circuit in accordance with claim 3, wherein the detection control panel includes a power source coupled to said first conductor and configured to reverse-bias said Zener diode.

5. A detection circuit in accordance with claim 1, wherein said voltage-stabilizing device is coupled to the detection control panel by said first conductor and by said second conductor.

6. A detection circuit in accordance with claim 1, wherein said voltage-stabilizing device is coupled to said initiating device by said first conductor and by said second conductor.

7. A detection system, comprising:
a detection control panel configured to detect a hazardous condition and to display a notification of the hazardous condition; and at least one detection circuit coupled to said detection panel, said at least one detection circuit comprising:
a first conductor and a second conductor;
at least one initiating device coupled to said detection control panel by said first conductor and by said second conductor; and
a voltage-stabilizing device configured to stabilize a voltage between said first conductor and said second conductor.

8. A detection system in accordance with claim 7, wherein said voltage-stabilizing device is a diode.

9. A detection system in accordance with claim 7, wherein said voltage-stabilizing device is a Zener diode.

10. A detection system in accordance with claim 9, further comprising a power source coupled to said first conductor and configured to reverse-bias said Zener diode.

11. A detection system in accordance with claim 7, wherein said voltage-stabilizing device is coupled to said detection control panel by said first conductor and by said second conductor.

12. A detection system in accordance with claim 7, wherein said voltage-stabilizing device is coupled to said initiating device by said first conductor and by said second conductor.

13. A detection system in accordance with claim 7, further comprising a communication module configured to transmit a notification of the hazardous condition to a remote device.

14. A method of assembling a detection system, said method comprising:
coupling a first conductor and a second conductor to at least one initiating device to form a detection circuit;
coupling a voltage-stabilizing device to the first conductor and the second conductor, the voltage-stabilizing device configured to stabilize a voltage between the first conductor and the second conductor; and
coupling the first conductor and the second conductor to a detection control panel configured to detect a hazardous condition.

15. A method in accordance with claim 14, wherein said coupling a voltage-stabilizing device to the first conductor and the second conductor comprises coupling a diode to the first conductor and the second conductor.

16. A method in accordance with claim 14, wherein said coupling a voltage-stabilizing device to the first conductor and the second conductor comprises coupling a Zener diode to the first conductor and the second conductor.

17. A method in accordance with claim 16, further comprising coupling a power source to the first conductor such that the power source reverse-biases the Zener diode.

18. A method in accordance with claim 14, further comprising coupling a power source to the detection circuit such that the power source supplies a first voltage to the detection circuit and the voltage-stabilizing device supplies a second voltage to the detection circuit.

19. A method in accordance with claim 18, wherein said coupling the first conductor and the second conductor to a detection control panel further comprises configuring the detection control panel to monitor a voltage level of the detection circuit.

20. A method in accordance with claim 19, wherein said coupling the first conductor and the second conductor to a detection control panel further comprises configuring the detection control panel to:
compare the voltage level of the detection circuit to a plurality of detection thresholds; and
determine a response based on the comparison.
